(19) United States
(12) Patent Application Publication
(10) Pub. No.: US 2006/0111155 A1
(43) Pub. Date: May 25, 2006

(54) Mobile terminal having support power pack

(75) Inventor: Chan-Woo Kim, Gyeonggi-Do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/282,475

(22) Filed: Nov. 21, 2005

(30) Foreign Application Priority Data
Nov. 22, 2004 (KR) 10-2004-0095924

(51) Int. Cl. H04B 1/38

(52) U.S. Cl. 455/574

(57) ABSTRACT

A mobile terminal including a support power pack attached to the mobile terminal and configured to hold at least one battery to provide an auxiliary power source for the mobile terminal, and a converter configured to convert a voltage of the at least one battery held in the support power pack into a voltage used by the mobile terminal.

This application claims priority to Korean Application No. 10-2004-0095924, filed in Korea on Nov. 22, 2004, the entire contents of which is incorporated by reference in its entirety.

### BACKGROUND OF THE INVENTION

1. Field of the Invention

The present invention relates to a mobile terminal, and more particularly, to a mobile terminal having a support power pack for providing an auxiliary power source for the mobile terminal.

2. Description of the Background Art

Current mobile communication terminals function much like a mobile entertainment system. For example, users can watch a video, listen to music, surf the Internet or play mobile games on their mobile terminal. Thus, users are spending more and more time using their mobile terminal.

Because users are spending more time using their mobile terminal, a high-capacity battery is required. Therefore, mobile terminal manufacturers have been trying to develop higher-capacity batteries and power-saving techniques for the mobile terminals.

Turning now to FIG. 1, which is an overview showing a general mobile terminal 100. As shown, the mobile terminal 100 includes a battery 110, which is manufactured exclusively for a model type of the mobile terminal 100. Further, the battery 100 is generally rechargeable and is usually mounted at a rear surface of the mobile terminal 100.

In addition, the battery 110 provides enough power so a user can talk for up to three hours and have a maximum standby time of more than one week. However, because the user uses multimedia functions on the mobile terminal such as watching a movie, listening to music, taking pictures, using the Internet etc. in addition to voice communication, the battery is consumed at a high rate. Moreover, because the exclusive battery is generally not compatible with a different model, the user cannot use the mobile terminal until the battery is recharged.

### SUMMARY OF THE INVENTION

Accordingly, one object of the present invention is to address the above noted and other problems.

Another object of the present invention is to provide a support power pack for a mobile terminal that functions as an auxiliary power source for the mobile terminal.

To achieve these and other advantages and in accordance with the purpose of the present invention, as embodied and broadly described herein, there is provided in accordance with one aspect of the present invention, a mobile terminal including a support power pack configured to be coupled to the mobile terminal and to hold at least one battery to provide an auxiliary power source for the mobile terminal, and a converter configured to convert a voltage of the battery held in the support power pack into a voltage used by the mobile terminal.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by way of illustration only, and thus are not limitative of the present invention, and wherein:

FIG. 1 is an overview showing a general mobile terminal;

FIGS. 2A and 2B are overviews showing a mobile terminal having a support power pack in accordance with one embodiment of the present invention; and

FIG. 3 is a flow diagram showing two power modes of the mobile terminal having the support power pack in accordance with the present invention.

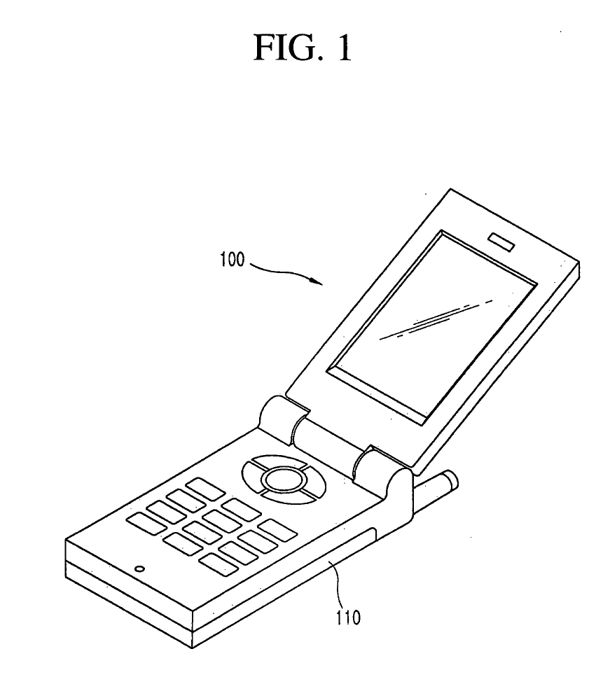

### DETAILED DESCRIPTION OF THE PREFERRED EMBODIMENTS

Reference will now be made in detail to the preferred embodiments of the present invention, examples of which are illustrated in the accompanying drawings.

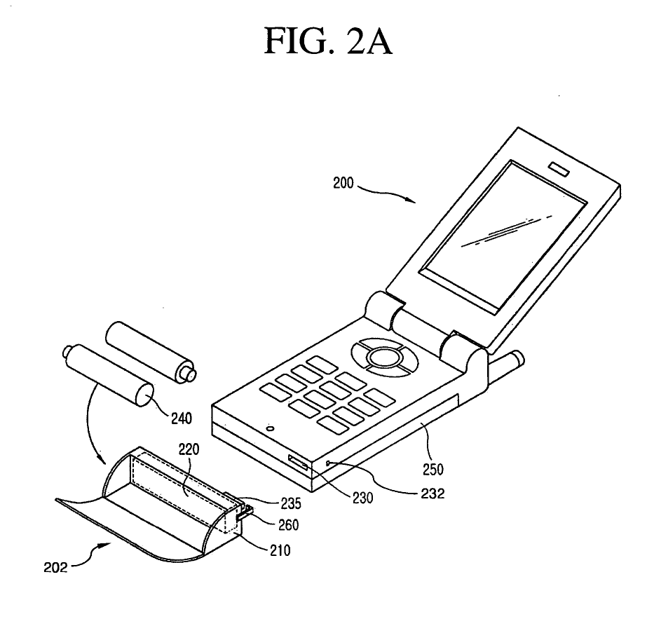

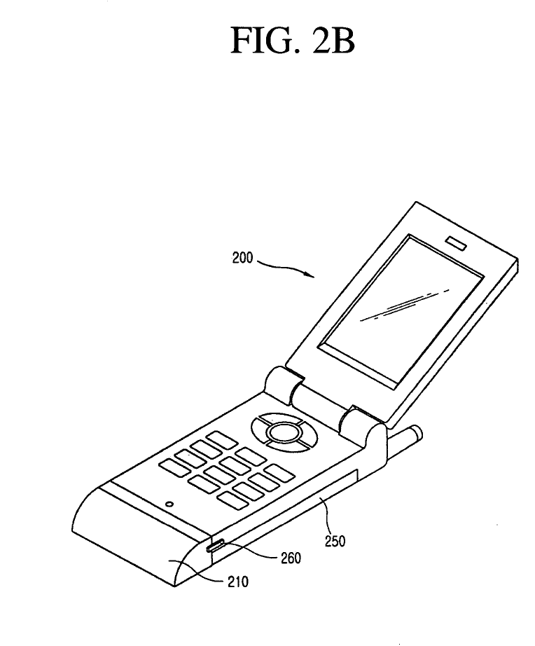

Turning first to FIGS. 2A and 2B, which are overviews showing a mobile terminal having a support power pack in accordance with one embodiment of the present invention. In more detail, FIG. 2A illustrates an expanded view of a support power pack 202 and FIG. 2B illustrates the support power pack 202 attached to a mobile terminal 200.

As shown in FIG. 2A, the support power pack 202 includes a battery holder 210 for holding a standard battery or batteries 240, which are used to provide an auxiliary power source for the mobile terminal 200. The support pack 202 also includes a DC/DC converter 220 for converting a voltage of the standard battery 240 into a usable voltage of the mobile terminal 200.

Further, as shown in FIGS. 2A and 2B, the battery holder 210 is detachably connected to the mobile terminal 200 by coupling a connection port 230 of the terminal 200 with a corresponding connection port 235 of the support power pack 202. Also, when the support power pack 202 is detached, the user can insert at least one standard battery 240 into the battery holder 210 to be used as another power source for the mobile terminal 200.

FIGS. 2A and 2B also illustrate the support power pack 202 including a fixing mechanism 260 in addition to the connection port 235. As shown in FIG. 2A, the fixing mechanism 260 engages with a fixing port 232 on the mobile terminal 200 and secures the coupling of the support power pack 202 to the terminal 200. The fixing mechanism 260 may be a hook-type mechanism as shown in FIG. 2A or may be a screw-type mechanism. Other variations are also possible.

In addition, FIGS. 2A and 2B illustrate the supply power pack 202 being detachably connected or coupled to the terminal 200. However, the power pack 202 may also be fixed permanently to the terminal 200 and include a cover that is opened to thereby insert the standard battery 240 into the battery holder 210.

Further, the DC/DC converter 220 converts the voltage of the standard battery 240 into a voltage of 3.0V to 4.2V, for example, used in the mobile terminal. The DC/DC converter 220 can also be mounted inside the battery holder 210 (as shown in FIG. 2A) or be mounted inside the mobile terminal 200. The converter 220 can also be a separate device and be coupled between the mobile terminal 200 and the battery holder 210. Also, the DC/DC converter 220 can be a step down or step up converter for respectively lowering or raising a level of the voltage output by the standard battery.

In addition, the mobile terminal 200 also includes a discharge checking mechanism configured to check a discharge status of the standard battery 240 and the exclusive battery 250. The discharge checking mechanism then displays an amount of remaining battery on a display of the terminal 200. The discharge mechanism may be a circuit that periodically checks a remaining battery amount of the standard battery 240 or the exclusive battery 250.

In addition, the mobile terminal 200 may also operate using just the exclusive battery 250 or just the standard battery 240. For example, when the user separates the exclusive battery 250 from the mobile terminal 200 to charge the exclusive battery 250, the mobile terminal 200 may be operated by mounting the support power pack 202 on the mobile terminal 200.

Further, the standard battery 240 is a standardized battery, which is available in a general retail store (e.g., a AA or AAA standard battery). The battery 240 may also be rechargeable or unrechargeable. In addition, the standard battery 240 may include an alkaline battery, a NiMH battery, a NiCd battery and the like.

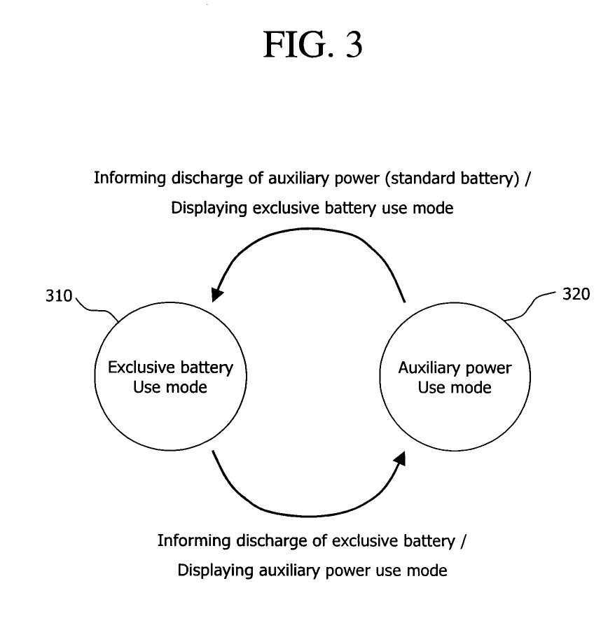

Turning next to FIG. 3, which is a flow diagram showing two power modes of the mobile terminal in accordance with one embodiment of the present invention. With reference to FIG. 3, the power modes of the mobile terminal include an exclusive power use mode 310 in which a power source of the exclusive battery 250 is used as the operating power, and an auxiliary power use mode 320 in which auxiliary power supplied from the standard battery 240 is used as the operating power. The modes 310 and 320 may be implemented using software, for example.

For example, the mobile terminal 200 generally includes a processor and related software programs to control an operation of the terminal 200. Thus, a control program for executing computer instructions to select or switch between the two modes may be included with the mobile terminal 200. A description of such a control program is given below.

In more detail, when both the exclusive battery 250 and the standard battery 240 are mounted on the mobile terminal 200, the control program of the mobile terminal 200 selects a power mode according to the a preset priority. For example, when using multimedia functions that use a substantial amount of power, the exclusive battery 250 may be set to have a higher priority than the auxiliary battery 240. Thus, when the user is playing a game, watching a movie, etc., the exclusive battery 250 will be used. The priorities may be predefined in a table of a memory on the mobile terminal 200. However, the user can also selectively determine which power mode will be used.

In addition, when the exclusive battery 250 and the standard battery 240 are mounted on the mobile terminal 200, when a power source of one of the two batteries is discharged beyond a certain level, the control program of the mobile terminal 200 panel the user about the discharge status by displaying a message on a display or by outputting a voice guide through a speaker, and then automatically switches over to using the other power mode. Alternatively, the mobile terminal 200 may prompt the user requesting the user to select the battery mode.

Moreover, when the user selects a power mode, which cannot supply power to the mobile terminal because of a particular problem (e.g., the battery needs to be recharged or the battery is inserted incorrectly), the control program of the mobile terminal 200 informs the user the selected power mode cannot be used by displaying a message on a display unit or by outputting a voice guide through a speaker.

As so far described, the mobile terminal having the support power pack in accordance with the present invention alleviates the inconveniences that voice communication cannot be performed when the exclusive battery is being recharged. The present invention also allows the user to use a variety of functions of the mobile terminal irrespective of the battery capacity, particularly, functions such as a multimedia functions that consume a lot of power using an easily available standard battery as an auxiliary power for the mobile terminal.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A mobile terminal, comprising:
a support power pack attached to the mobile terminal and configured to hold at least one battery to provide an auxiliary power source for the mobile terminal; and
a converter configured to convert a voltage of the at least one battery held in the support power pack into a voltage used by the mobile terminal.

2. The mobile terminal of claim 1, wherein the support power pack comprises:
a battery holding section configured to securely hold the at least one battery; and
at least one connection port configured to be detachably coupled to a corresponding at least one connection port on the mobile terminal such that a user can detach the support power pack and insert or remove the at least one battery.

3. The mobile terminal of claim 2, wherein the support power pack further includes a fixing mechanism configured to engage with a portion of the mobile terminal so as to secure the support power pack attached to the mobile terminal.

4. The mobile terminal of claim 3, wherein the fixing mechanism comprises at least one screw or a hook-protruding portion configured to engage with a portion of the mobile terminal.

5. The mobile terminal of claim 1, wherein the converter converts the voltage of the at least one battery into a voltage of 3.0 V to 4.2 V used by the mobile terminal.

6. The mobile terminal of the claim 2, wherein the converter is mounted inside the battery holder or mounted inside the mobile terminal.

7. The mobile terminal of the claim 1, wherein the converter is a separate device and is coupled between the mobile terminal and the support power pack.

8. The mobile terminal of claim 1, wherein the converter comprises:
a step down converter configured to lower a level of a voltage output by the at least one battery and to output the lowered voltage to be used as a power source of the mobile terminal; or
a step up converter configured to raise the level of the voltage output by the at least one battery and to output the raised voltage to be used as the power source for the mobile terminal.

9. The mobile terminal of claim 1, further comprising:
a primary battery attached to the mobile terminal and being manufactured according to a specific model of the mobile terminal and configured to provide a primary power source to the mobile terminal; and
a discharge checking mechanism configured to check a discharge status of the primary battery and the at least one battery, and to display an amount of remaining power left in the primary battery and the at least one battery.

10. The mobile terminal of claim 1, further comprising:
a control program configured to select one of a main power use mode to use the primary battery as an operating power for the mobile terminal, or an auxiliary power use mode to use the at least one battery as the operating power for the mobile terminal.

11. The mobile terminal of claim 10, wherein, when a power source of either the primary battery or the at least one battery is discharged more than a predetermined level, the control program informs a user of the mobile terminal about a discharge status and selects either the main power use mode or the auxiliary power use mode that has not discharged more than the predetermined level.

12. The mobile terminal of claim 10, wherein the control program selects the main power and auxiliary power use modes based on predetermined priorities set in the mobile terminal.

13. The mobile terminal of claim 10, wherein the control program further prompts a user of the mobile terminal to select one of the main power or auxiliary power use modes.

14. The mobile terminal of claim 13, wherein, when there is a problem in the power mode selected by the user, the control program of the mobile terminal informs the user that the power mode cannot be used because of the problem.

15. The mobile terminal of claim 1, wherein the at least one battery comprises a standard battery not specific to the mobile terminal.

16. The mobile terminal of claim 1, wherein the support power pack is detachably coupled to the mobile terminal.
